(19) United States
(12) Patent Application Publication
(10) Pub. No.: US 2008/0238902 A1
(43) Pub. Date: Oct. 2, 2008

(54) Display device with automatic power on-off switching

(75) Inventor: Shun-Ming Huang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/080,013

(22) Filed: Mar. 31, 2008

(30) Foreign Application Priority Data
Mar. 30, 2007 (CN) 200710073756.9

(51) Int. Cl. G09G 5/00

(52) U.S. Cl. 345/204

(57) ABSTRACT

An exemplary display device (200) includes a display module (230), a power supply circuit (240), a detecting circuit (210), and an anti-interfering circuit (250). The detecting circuit detects a predetermined type of radiation from an object near the display module. The anti-interfering circuit determines whether the radiation is from a potential user of the display device via identifying the frequency of the radiation and the time period that the radiation subsists. The power supply circuit provides power to the display module according to the identifying result.

### FIELD OF THE INVENTION

The present invention relates to a display device capable of automatically controlling the switching on and switching off of a power supply thereof.

### GENERAL BACKGROUND

Generally, a display device employs a mechanical switch key to control a power supply thereof. When the display device is turned on or turned off, a user needs to manually press the mechanical switch key. This is somewhat inconvenient for the user, and accordingly the display device is desired to be capable of automatically controlling the power supply thereof.

FIG. 2 is a block diagram of a conventional display device that can control the power supply thereof automatically. The display device 100 includes a detecting circuit 110, a control circuit 120, a power supply circuit 140, and a display module 130. The detecting circuit 110, the control circuit 120, the power supply circuit 140, and the display module 130 are electrically coupled in series. The detecting circuit 110 includes an infrared (IR) sensor (not shown).

In operation, the IR sensor of the detecting circuit 110 detects any IR beams in front of the display device 100. When a person is in front of the display device 100, IR beams are emitted from the person and received by the IR sensor. The detecting circuit 110 detects the presence of the person, and outputs a first signal to the control circuit 120. In response to the first signal, the control circuit 120 controls the power supply circuit 140 to provide power to the display module 130. Thereby, the display module 130 enters a normal working state and can display images. When the IR sensor does not receive any IR beams from the person, the detecting circuit 110 detects the absence of the person in front of the display device 100, and outputs a second signal to the control circuit 120. In response to the second signal, the control circuit 120 controls the power supply circuit 140 to stop providing power to the display module 130. Thereby, the display device 100 is turned off.

The display device 100 utilizes the detecting circuit 110 to determine whether a user is in front of the display device 100, and is thereby capable of automatically turning on or turning off. However, when the user is absent and another person passes by the front of the display device 100, the passer-by is liable to trigger the detecting circuit 110 to mistakenly consider the passer-by as being the user. In this circumstance, the power supply circuit 140 may be controlled to provide power to the display module 130 in error, such that the display device 100 is unnecessarily turned on. Thus, the reliability of the automatic power supply control of the display device 100 is somewhat low.

It is, therefore, desired to provide a display device which overcomes the above-described deficiencies.

### SUMMARY

In a first aspect, a display device includes a display module, a power supply circuit, a detecting circuit, and an anti-interfering circuit. The detecting circuit detects a predetermined type of radiation from an object near the display module. The anti-interfering circuit determines whether the radiation is from a potential user of the display device via identifying the frequency of the radiation and the time period that the radiation subsists. The power supply circuit provides power to the display module according to the identifying result.

In a second aspect, a display device includes a display module, a power supply circuit, a detecting circuit configured to receive a predetermined type of signal from an ambient environment of the display module, and an anti-interfering circuit. The anti-interfering circuit distinguishes whether the signal is from a potential user of the display device via the time period that the signal subsists. The power supply circuit provides power to the display module according to the distinguishing result of the anti-interfering circuit.

In a third aspect, a display device a display module, an identification element for identifying whether an object in an ambient environment of the display module is a potential user of the display device according to a time period that a predetermined type of radiation emitted from the object lasts, and a control element for switching on or switching off the display module according to the identifying result received from the identification element.

Other novel features and advantages will become more apparent from the following detailed description when taken in conjunction with the accompanying drawings.

### BRIEF DESCRIPTION OF THE DRAWINGS

FIG. 1 is a circuit diagram of a display device according to an exemplary embodiment of the present invention.

FIG. 2 is a block diagram of a conventional display device, which is capable of automatically controlling a power supply thereof.

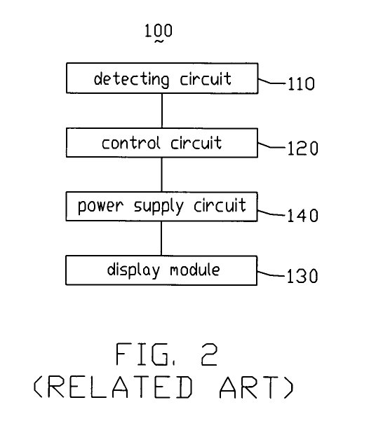

### DETAILED DESCRIPTION OF PREFERRED EMBODIMENTS

Reference will now be made to the drawings to describe preferred and exemplary embodiments of the present invention in detail.

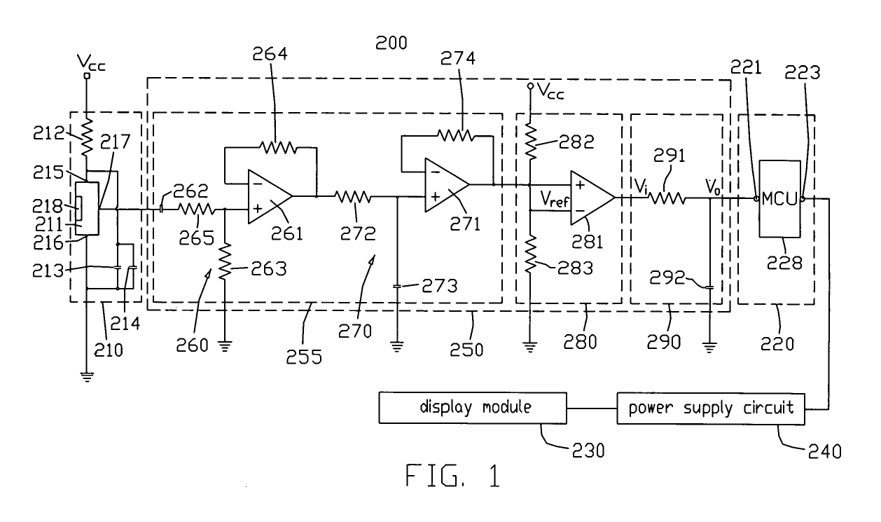

FIG. 1 is a circuit diagram of a display device according to an exemplary embodiment of the present invention. The display device 200 includes a detecting circuit 210, an anti-interfering circuit 250, a control circuit 220, a power supply circuit 240, and a display module 230.

The detecting circuit 210 includes a detecting member 211, a first resistor 212, a first capacitor 213, and a second capacitor 214. The detecting member 211 is an IR sensor, and the IR sensor can be a selected one of a quantum type IR sensor and a thermal type IR sensor. The detecting member 211 includes a receiving portion 218, a power input terminal 215, a grounding terminal 216, and an output terminal 217. The receiving portion 218 is configured for receiving IR beams from the front of the display device 200. The power input terminal 215 is configured for receiving a power voltage V_{cc} via the first resistor 212 to enable the detecting member 211 to work. The grounding terminal 216 is directly grounded. The output terminal 217 is configured for outputting a voltage signal according to the IR beams received by the receiving portion 218. Moreover, the first capacitor 213 and the second capacitor 214 are electrically coupled in parallel, and further electrically coupled between the power input terminal 215 and the grounding terminal 216.

The anti-interfering circuit 250 is configured to filter unwanted voltage signals outputted by the detecting circuit 210 corresponding to interfering IR beams. The anti-interfering circuit 250 includes a band pass filter circuit 255, a comparing circuit 280, and a delay circuit 290. The band pass filter circuit 255 includes a high pass filter circuit 260 and a low pass filter circuit 270 electrically coupled in series.

The high pass filter circuit 260 includes a first integrated operational amplifier (IOA) 261, a third capacitor 262, a second resistor 263, a third resistor 264, and a fourth resistor 265. One end of the third capacitor 262 serves as an input terminal of the band pass filter circuit 255, and is electrically coupled to the output terminal 217 of the detecting member 211. The other end of the third capacitor 262 is electrically coupled to a non-inverting terminal of the first IOA 261 via the fourth resistor 265, and the non-inverting terminal of the first IOA 261 is grounded via the second resistor 263. An inverting terminal of the first IOA 261 is electrically coupled to an output terminal of the first IOA 261 via the third resistor 264, and the output terminal of the first IOA 261 serves as an output terminal of the high pass filter circuit 260. Moreover, a cut-off frequency of the high pass filter circuit 260 (i.e. a lower cut-off frequency f_{L} of the band pass filter circuit 255) is determined by the following formula: f_{L}=1/(2ρR₁C₁), wherein R₁ represents a sum of resistances of the second resistor 263 and the fourth resistor 265, and C₁ represents a capacitance of the third capacitor 262. In the display device 200, the cut-off frequency of the high pass filter circuit 260 is controlled to be 3×10¹³ Hz (hertz).

The low pass filter circuit 270 includes a second IOA 271, a fifth resistor 272, a fourth capacitor 273, and a sixth resistor 274. A non-inverting terminal of the second IOA 271 is electrically coupled to the output terminal of the first IOA 261 via the fifth resistor 272, and is grounded via the fourth capacitor 273. An inverting terminal of the second IOA 271 is electrically coupled to an output terminal of the second IOA 271 via the sixth resistor 274. The output terminal of the second IOA 271 serves as an output terminal of the band pass filter circuit 255. Moreover, a cut-off frequency of the low pass filter circuit 270 (i.e. a upper cut-off frequency f_{H} of the band pass filter circuit 255) is determined by the following formula: f_{H}=1/(2ρR₂C₂), wherein R₂ represents a resistance of the fifth resistor 272, and C₂ represents a capacitance of the fourth capacitor 273. In the display device 200, the cut-off frequency of the low pass filter circuit 270 is controlled to be 3.3×10¹³ Hz. That is, a so-called pass-band of the band pass filter circuit 255 is in a range from 3×10¹³ Hz to 3.3×10¹³ Hz.

The comparing circuit 280 includes a voltage comparator 281, a seventh resistor 282, and an eighth resistor 283. The seventh resistor 282 and the eighth resistor 283 are electrically coupled in series, and cooperatively form a voltage divider to provide a reference voltage V_{ref} based on the power voltage V_{cc}. An inverting terminal of the voltage comparator 281 is configured to receive the reference voltage V_{ref}. A non-inverting terminal of the voltage comparator 281 is electrically coupled to the output terminal of the band pass filter circuit 255.

The delay circuit 290 is a resistance-capacitance (RC) integrator circuit, which includes a ninth resistor 291 and a fifth capacitor 292. One end of the ninth resistor 291 serves as an input terminal of the delay circuit 290, and is electrically coupled to the output terminal of the voltage comparator 281. The other end of the ninth resistor 292 serves as an output terminal of the delay circuit 290, and is grounded via the ninth capacitor 292. An output voltage Vₒ of the delay circuit 290 is determined by the following formula: Vₒ=Vᵢ(1−e^{-t/τ}), wherein Vᵢ represents an input voltage of the delay circuit 290, and t represents a time period. Moreover, τ represents a timing constant of the delay circuit 290, which is determined by τ=R₃C₃, wherein R₃ represents a resistance of the ninth resistor 291, and C₃ represents a capacitance of the fifth capacitor 292. As shown in the formula Vₒ=Vᵢ(1−e^{-t/τ}), the output voltage Vₒ increases with elapsing of time, and reaches a peak value that is equal to the input voltage Vᵢ after a predetermined time period which is the same as the timing constant τ. That is, the delay circuit 290 is capable of delaying the input voltage signal Vᵢ for a predetermined time period t=τ=R₃C₃ before outputting the voltage signal Vᵢ.

The control circuit 220 includes a micro control unit (MCU) 228. The MCU 228 can be a scaler of the display device 200, and includes an input port 221 and an output port 223. The input port 221 is electrically coupled to the output terminal of the delay circuit 290, and the output port 223 is electrically coupled to the power supply circuit 240. The power supply circuit 240 is configured for providing power to the display module 230.

In operation, the detecting circuit 210 detects IR beams in front of the display device 200 via the detecting member 211, and generates a first voltage signal according to the detecting result. In particular, if any person is present, the first voltage signal has frequency components corresponding to the IR beams emitted by the person's body. If not, the first voltage signal does not have any such frequency components.

The first voltage signal is then filtered by the band pass filter circuit 255, and is converted to a second voltage signal. In detail, the frequency components thereof less than 3×10¹³ Hz are filtered by the high pass filter circuit 260, and the frequency components thereof greater than 3.3×10³ Hz are filtered by the low pass filter circuit 270. Thereby, the second voltage signal only has frequency components in a range from 3×10¹³ Hz to 3.3×10¹³ Hz. It is widely known that wavelength of the IR radiation beams emitted by a person's body are generally in a range from 9000 nm (nanometers) to 10000 nm, that is, the frequency components of such IR beams are also in the range from 3×10¹³ Hz to 3.3×10¹³ Hz. Thus if the IR beams received by the detecting circuit 210 are emitted by ambient objects such as lamps, the first voltage signal is diminished while transmitting through the band pass filter circuit 255, such that the second voltage signal is a low voltage. If the IR beams are emitted by a person's body, that is, the IR beams are emitted by a user of the display device 200 or emitted by another person passing by the front of the display device 200, the first voltage signal passes through the band pass filter circuit 255 without being diminished, such that the second voltage signal is a high voltage. As described above, the band pass filter circuit 255 determines whether the IR beams are emitted from a person's body or emitted from an ambient object via identifying the frequency thereof.

After that, the voltage comparator 281 compares the second voltage signal with the reference voltage V_{ref}, and outputs a first control signal to the delay circuit 290 according to the comparison result. In detail, if the second voltage signal corresponds to IR beams emitted by an ambient object, it is less than the reference voltage V_{ref}, and the first control signal is also a low voltage. If the second voltage signal corresponds to IR beams emitted by the user' body or the passer-by's body, it is greater than the reference voltage V_{ref}, and the first control signal is also a high voltage.

Then the first control signal charges the fifth capacitor 292. An output voltage Vₒ of the delay circuit 290 increases according to the formula: Vₒ=Vᵢ(1−e^{-t/τ}) with the elapse of time, wherein Vᵢ represents the voltage value of the first control signal. After a delay time period the same as the timing constant τ of the delay circuit 290, the output voltage reaches the value of the first control signal. That is, the delay circuit 290 delays the first control signal for a predetermined time period before outputting to the MCU 228.

In detail, due to the delaying process of the delay circuit 290, the first control signal is operated as follows. If the first control signal is a low voltage corresponds to IR beams emitted by an ambient object, after the delaying process, the first control signal remains as a low voltage. If the first control signal is a high voltage corresponds to IR beams emitted by the user's body, after the delaying process, the first control signal remains as a high voltage. However, if the first control signal is a high voltage corresponding to IR beams emitted by a passer-by's body, because such IR beams together with the passer-by disappear from the front of the display device 200 in a short time period, the corresponding first control signal also lasts for the short time period. This causes the first control signal to be incapable of charging the fifth capacitor 292 sufficiently, and the first control signal is converted to a low voltage signal by the delay circuit 290. As described above, the delay circuit 290 determines whether the IR beams are emitted from the user or emitted from the passer-by via identifying the time period that the IR beams last.

The MCU 228 then provides a second control signal to the power supply circuit 240 according to the first control signal. In particular, when the first control signal is a high voltage, it is greater than a threshold voltage of the input port 221 of the MCU 228. The second control signal controls the power supply circuit 240 to provide power to the display module 230. Thereby, the display module 230 enters a normal working state, and the display device 200 is switched on. When the first control signal is a low voltage, it is less than the threshold voltage of the input port of the MCU 228. The second control signal controls the power supply circuit 240 to stop providing power to the display module 230. Thereby, the display module 230 is disabled, and the display device 200 is switched off.

In summary, the detecting circuit 210 detects the IR beams from the front of the display module 230 of the display device 200. The anti-interfering circuit 250 identifies the frequency of the IR beams to determine whether the IR beams are from a person's body or from an ambient object via the band pass filter 255, and further identifies the time period that the IR beams subsist via the delay circuit 290 to determine whether IR beams are from the user's body or from the passer-by's body. That is, the detecting circuit 210 and the anti-interfering circuit 250 cooperatively form an identification element to identify the presence or absence of the user. The control circuit 220 then controls the power supply circuit 240 to provide power to the display module 230, such that display device 200 is capable of switching on or switching off automatically. In other words, the control circuit 220 and the power supply circuit 240 cooperatively form a control element to switch on or switch off a power supply of the display device 200.

Due to the above-described identifying processes of the delay circuit 290, IR beams emitted from a passer-by's body are prevented from triggering the detecting circuit 210 to mistakenly consider the passer-by as being the user. Therefore, the possibility of automatically switching on or switching off in error is reduced, and the reliability of the automatic power supply control of the display device 200 is improved.

It is to be further understood that even though numerous characteristics and advantages of preferred and exemplary embodiments have been set out in the foregoing description, together with details of the structures and functions of the embodiments, the disclosure is illustrative only; and that changes may be made in detail within the principles of the present invention to the full extent indicated by the broad general meaning of the terms in which the appended claims are expressed.

What is claimed is:

1. A display device, comprising:
a display module;
a power supply circuit;
a detecting circuit; and
an anti-interfering circuit;
wherein the detecting circuit detects a predetermined type of radiation from an object near the display module, the anti-interfering circuit determines whether the radiation is from a potential user of the display device via identifying the frequency of the radiation and the time period that the radiation subsists, and the power supply circuit provides power to the display module according to the identifying result.

2. The display device as claimed in claim 1, wherein the power supply circuit stops providing power to the display module upon the condition that the identifying result indicates the frequency of radiation does not corresponds to a person's body.

3. The display device as claimed in claim 1, wherein the power supply circuit stops providing power to the display module upon the condition that the identifying result indicates the time period that the radiation subsist is within a predetermined time period.

4. The display device as claimed in claim 1, wherein the anti-interfering circuit comprises a band-pass filter, the band pass filter is configured to distinguish whether the signal is from a human body.

5. The display device as claimed in claim 1, wherein the anti-interfering circuit comprises a delay circuit, the delay circuit is configured to identify whether the time period that the radiation subsist is within a predetermined time period.

6. The display device as claimed in claim 5, wherein the delay circuit is an integrator circuit.

7. The display device as claimed in claim 6, wherein the integrator circuit comprises a first resistor and a first capacitor, an end of the first resistor serves as an input terminal of the integrator circuit, the other end of the first resistor serves as an output terminal of the integrator circuit, and is grounded via the first capacitor.

8. The display device as claimed in claim 4, wherein the pass-band of the band pass filter circuit is in a range from 3×10¹³ Hz to 3.3×10¹³ Hz.

9. The display device as claimed in claim 8, wherein the band pass filter circuit comprises a high pass filter circuit and a low pass filter circuit.

10. The display device as claimed in claim 9, wherein the high pass filter circuit comprises a first operational amplifier, a second capacitor, a second resistor, and a third resistor, an end of the second capacitor serves as an input terminal of the high pass filter circuit, the other end of the second capacitor is electrically coupled to a non-inverting terminal of the first operational amplifier, and is grounded via the second resistor, an inverting terminal of the first operational amplifier is electrically coupled to an output terminal of the first operational amplifier via the third resistor.

11. The display device as claimed in claim 10, wherein the low pass filter circuit comprises a second operational amplifier, a fourth resistor, a fifth resistor, and a third capacitor, an end of the fourth resistor serves as an input terminal of the low pass filter circuit, the other end of the fourth resistor is electrically coupled to a non-inverting terminal of the second operational amplifier, and is grounded via the third capacitor, an inverting terminal of the second operational amplifier is electrically coupled to an output terminal of the second operational amplifier via the fifth resistor.

12. The display device as claimed in claim 11, wherein the anti-interfering circuit further comprises a comparing circuit, the comparing circuit is configured to compare the signal outputted by the low pass filter circuit with a reference signal.

13. The display device as claimed in claim 12, wherein the comparing circuit comprises a voltage comparator, an inverting terminal of the voltage comparator is configured for receiving a reference signal, and a non-inverting terminal of the voltage comparator is electrically coupled to the output terminal of the second operational amplifier

14. The display device as claimed in claim 1, further comprising a control circuit, the control circuit is configured to control the power supply circuit to provide power according to the identifying result.

15. The display device as claimed in claim 14, wherein the control circuit comprises a micro control unit having an input port and an output port, the input port is electrically coupled to the anti-interfering circuit, and the output port is electrically coupled to the power supply circuit.

16. The display device as claimed in claim 15, wherein the micro control unit is a scaler.

17. The display device as claimed in claim 1, wherein the detecting circuit comprises an infrared sensor, and the signal detected by the detecting circuit is infrared signal.

18. The display device as claimed in claim 17, wherein the infrared sensor is a selected one of a quantum type infrared sensor or a thermal type infrared sensor.

19. A display device, comprising:
a display module;
a power supply circuit;
a detecting circuit configured to receive a predetermined type of signal from an ambient environment of the display module; and
an anti-interfering circuit;
wherein the anti-interfering circuit distinguishes whether the signal is from a potential user of the display device via the time period that the signal subsists, and the power supply circuit provides power to the display module according to the distinguishing result of the anti-interfering circuit.

20. A display device, comprising:
a display module;
an identification element for identifying whether an object in an ambient environment of the display module is a potential user of the display device according to a time period that a predetermined type of radiation emitted from the object lasts; and
a control element for switching on or switching off the display module according to the identifying result received from the identification element.
